(19) United States
(12) Patent Application Publication
(10) Pub. No.: US 2005/0098983 A1
(43) Pub. Date: May 12, 2005

(54) Frame structure for strollers

(75) Inventors: Huang-Yi Cheng, Chia-I Hsien (TW); Ho-Sheng Chen, Chia-I Hsien (TW); Yung-Shuen Lin, Chia-I Hsien (TW); Ming-Chi Tsai, Yunlin Hsien (TW)

Correspondence Address: BIRCH STEWART KOLASCH & BIRCH, PO BOX 747, FALLS CHURCH, VA, 22040-0747, US

(73) Assignee: Link Treasure Limited

(21) Appl. No.: 10/984,994

(22) Filed: Nov. 10, 2004

(30) Foreign Application Priority Data
Nov. 12, 2003 (TW) 92220054

(51) Int. Cl. B62B 7/06

(52) U.S. Cl. 280/642

(57) ABSTRACT

A frame structure for strollers includes a seat rack pivotally which is coupled with a front wheel bracket and a rear wheel bracket. The seat rack has a font seat bar and a rear seat bar that are pivotally coupled with each other. The rear seat bar is pivotally coupled with a sliding driving member, which may be driven to slide by a linkage member while the frame is folding to press the rear seat bar and fold the seat rack and also move the front wheel bracket and the rear wheel bracket close to each other to achieve smooth folding of the frame.

### FIELD OF THE INVENTION

The present invention relates to a frame structure for strollers that includes a seat rack pivotally coupling with a front wheel bracket and a rear wheel bracket. The seat rack has a front seat bar and a rear seat bar folding in an inverse V shape through a sliding driving member while the frame is folding to move the front wheel bracket and the rear wheel bracket close to each other.

### BACKGROUND OF THE INVENTION

The conventional strollers generally have linkage bars pivotally coupled with one another and a joint assembly to connect the linkage bars that is controlled by a release mechanism. The joint assembly has a latch mechanism to release and lock the stroller in a folding position for storing and an extending position for use. Reference can be found in U.S. Pat. No. 5,772,235. However, the linkage bar structure mentioned above is complicated and difficult to fabricate and assemble. As a lot of linkage bars are involved, the frame is heavy and difficult to carry. Folding of the frame cannot be done smoothly.

### SUMMARY OF THE INVENTION

In view of the aforesaid problems, the primary object of the present invention is to provide a frame structure that has a front wheel bracket, a rear wheel bracket, a coupling seat, a handle tube, a connection element, a linkage member, a seat rack and a driving member that are pivotally coupled with one another. The seat rack pivotally connects the front and rear wheel brackets, and includes a front seat bar and a rear seat bar that are pivotally coupled with each other. The rear seat bar is pivotally coupled with the sliding driving member. The driving member is driven by the linkage member while the frame is folding to push the rear seat bar so that the seat rack is folded and drives the front wheel bracket and the rear wheel bracket close to each other or extending thereby to achieve smooth folding.

The foregoing, as well as additional objects, features and advantages of the invention will be more readily apparent from the following detailed description, which proceeds with reference to the accompanying drawings. The descriptions and drawings are for illustrative purpose only, and not the limitation of the invention.

### BRIEF DESCRIPTION OF THE DRAWINGS

FIG. 1 is a perspective view of the invention in an extended condition.

FIG. 2 is a schematic side view of the invention in a folding condition.

FIG. 3 is a schematic view of the invention as the invention is folding.

FIG. 4 is a schematic view of the invention in a collapsed condition.

### DESCRIPTION OF THE PREFERRED EMBODIMENT

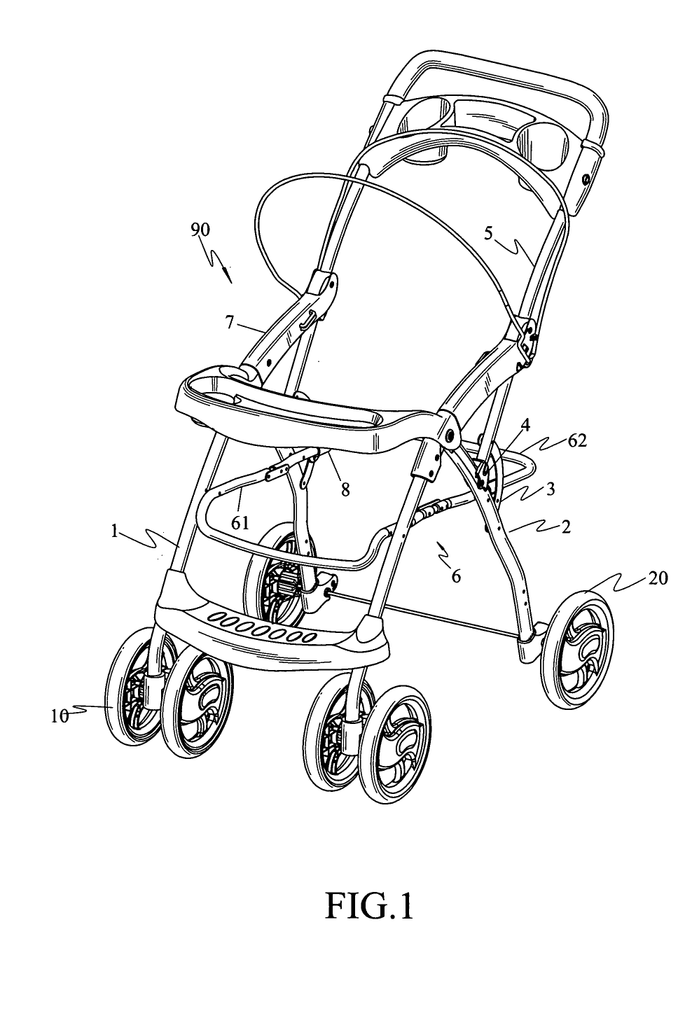

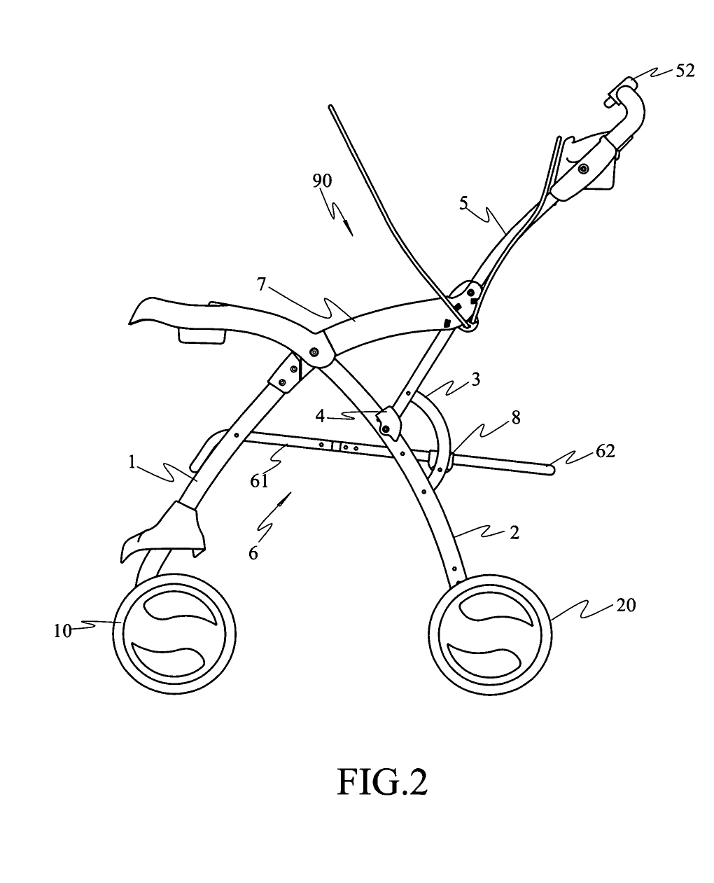

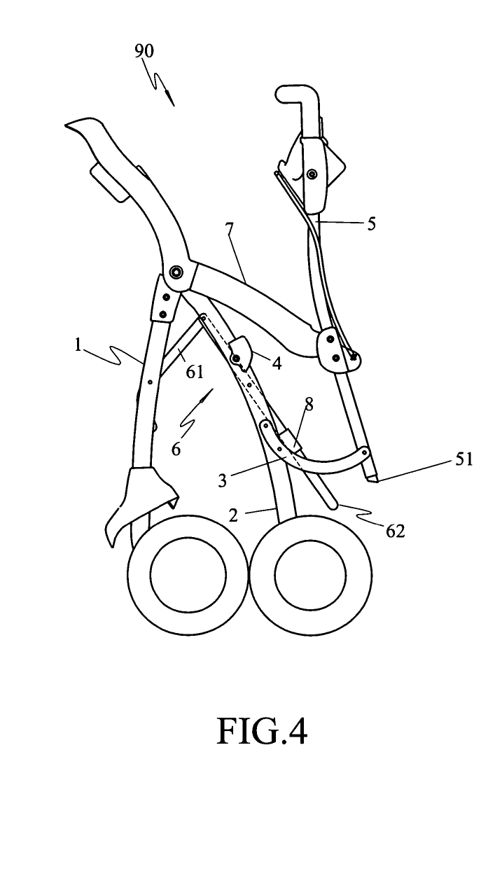

Referring to FIGS. 1 and 2, the stroller frame 90 according to the invention includes a front wheel bracket 1, a rear wheel bracket 2, a linkage member 3, a coupling seat 4, a handle tube 5, a seat rack 6, a connection element 7 and a driving member 8 that are pivotally coupled with one another to form an extended condition (referring to FIG. 1) and a collapsed condition (referring to FIG. 4).

The front wheel bracket 1 has a lower end coupled with a front wheel 10 of the stroller and an upper end pivotally coupled with the connection element 7. The rear wheel bracket 2 has a lower end coupled with a rear wheel 20 and an upper end pivotally coupled with the connection element 7. The coupling seat 4 is located between the two ends of the rear wheel bracket 2 to latch the handle tube 5, to keep the frame 90 in extended condition.

The handle tube 5 is for moving the stroller and has two ends pivotally coupled with the connection element 7. The connection element 7 has another end pivotally coupled with the front wheel bracket 1 and the rear wheel bracket 2. The handle tube 5 has a lower end fastened to a latch member 51 which may be engaged with the coupling seat 4 to latch the rear wheel bracket 2 or to be disengaged from the coupling seat 4 to release the rear wheel bracket 2. The connection element 7 and the handle tube 5 are latched. In this embodiment, the latch member 51 is moved by a release mechanism 52. Reference of the release mechanism 52 can be found in U.S. patent publication No. 20030071441 or U.S. Pat. No. 6,443,479.

The linkage member 3 has one end pivotally coupled on a lower end of the handle 5 and another end pivotally coupled on a middle portion of the rear wheel bracket 2. The seat rack 6 includes a front seat bar 61 and a rear seat bar 62. The front seat bar 61 is pivotally coupled on the front wheel bracket 1. The rear seat bar 62 is pivotally coupled on the rear wheel bracket 2. Through extension and folding of the seat rack 6, the front wheel bracket 1 and the rear wheel bracket 2 are extended and folded. The driving member 8 is slidably mounted on the rear seat bar 62 and connected to the linkage member 3, and is movable by the driving of the linkage member 3.

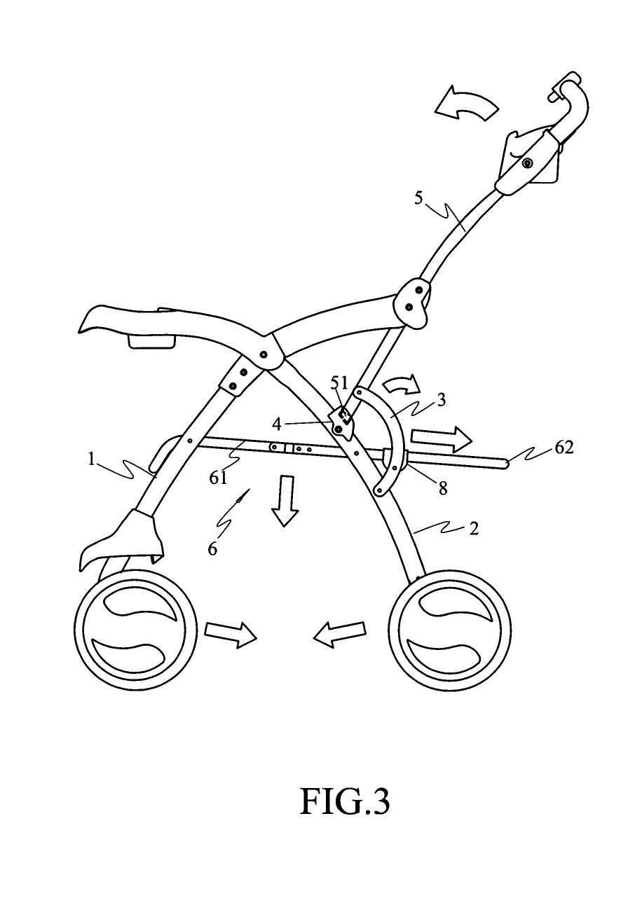

By means of the construction set forth above, when the frame 90 is extended, the latch member 51 on the lower end of the handle tube 5 is latched on the coupling seat 4 on the rear wheel bracket 2 to form an anchor condition so that all other bar elements are latched and cannot be turned to seat a baby. For folding, release the latch member 51, move the handle tube 5 forwards to drive the linkage member 3 to turn. The driving member 8 pivotally coupled with the linkage member 3 also is driven to move, and the rear seat bar 62 and the front seat bar 61 are pushed to form an inverse V shape, thereby the front wheel bracket 1 and the rear wheel bracket 2 are moved close to each other to fold the frame (referring to FIG. 3).

Compared with the conventional stroller frames, the present invention provides a simpler structure and makes folding of the frame smoother.

1. A frame structure for a stroller, comprising:
a front wheel bracket, for coupling with front wheels of the stroller;
a rear wheel bracket, for coupling with rear wheels of the stroller, having a coupling seat located between two ends thereof;
a handle tube, for moving the stroller, having two ends pivotally connected by a connection element, which serves as armrests on two sides of the stroller and which has one end pivotally coupled with the front wheel bracket and the rear wheel bracket, and the handle tube having one end detachably engaged with the coupling seat to form an interlocking condition among the rear wheel bracket, the armrests and the handle tube and to form a release condition among the rear wheel bracket, the armrests and the handle tube when disengaged;
a linkage member, having two ends pivotally connected the handle tube and the rear wheel bracket;
a seat rack, including a front seat bar and a rear seat bar that are pivotally coupled with each other, and being pivotally coupled with the front wheel bracket and the rear wheel bracket; and
a driving member, slidably mounted on the rear seat bar and connecting to the linkage member to be driven by the linkage member to slide while the frame is folding to fold the seat rack and move the front wheel bracket and the rear wheel bracket close to each other.

2. The frame structure for a stroller of claim 1, wherein the handle tube has a latch member on a lower end engageable with the coupling seat to keep the frame in an extended condition.

3. The frame structure for a stroller of claim 2, wherein the latch member is moved by a release device.

4. The frame structure for a stroller of claim 3, wherein the release device is mounted onto the handle tube.

5. The frame structure for a stroller of claim 1, wherein the driving member is slidably mounted onto the rear seat bar to be driven by the linkage member to press the rear seat bar while the frame is folding to make the seat rack to form an inverse V shape thereby to move the front wheel bracket and the rear wheel bracket close to each other.

6. The frame structure for a stroller of claim 1, wherein the front wheel bracket and the rear wheel bracket have respectively an upper end pivotally coupled with the connection element.
